(19) United States
(12) Patent Application Publication
(10) Pub. No.: US 2024/0112533 A1
(43) Pub. Date: Apr. 4, 2024

(54) SKILLS-BASED, SPORTS WAGERING

(71) Applicant: TSG Developments Investments, Inc., Hunt Valley, MD (US)

(72) Inventors: Garrett Biemer, Boston, MA (US); Paul Williams, Hollywood, FL (US); Zachary Leifer, Las Vegas, NV (US)

(73) Assignee: TSG Developments Investments, Inc., Hunt Valley, MD (US)

(21) Appl. No.: 18/275,964

(22) PCT Filed: Feb. 8, 2022
(86) PCT No.: PCT/US22/15633

§ 371 Date: Aug. 4, 2023

Related U.S. Application Data
(60) Provisional application No. 63/146,811, filed on Feb. 8, 2021.

(51) Int. Cl. G07F 17/32

(52) U.S. Cl. CPC G07F 17/323; G07F 17/3288

(57) ABSTRACT

A wagering tool, system or method that allows a player to make skill-based bets on a wide range of sporting events includes the following modules: (a) pricing, which provides the odds on the various competitors, (b) historical event, which stores relevant information pertaining to prior sporting events of the same type that the player is considering placing a bet, (c) forecast, which analyzes prior, similar sporting to determine: (i) similar prior events to the upcoming sporting event, (ii) the shared characteristics of the winners' of these prior events, (iii) the percentage probability that each competitor will win, (d) WIN/Odds, which identifies available “value bets” in the upcoming sporting event, (e) score generation, which rank orders available bets on a “value index” scale, (f) derivative, which identifies bets that could be of special interest; along with a searchable index database, which stores the outputs of the system's various modules and continually updates them; and a user interface that is configured to allow a player to interact with the wagering tool.

### CROSS-REFERENCE TO RELATED APPLICATION

This application claims the benefit of Provisional patent Application No. PPA 63/146,811, filed Feb. 8, 2021 by the present inventors. The teachings of this application are incorporated herein by reference to the extent that they do not conflict with the teaching herein.

### BACKGROUND OF THE INVENTION

### 1. Field of the Invention

The present invention generally relates to online, amusement devices. More specifically, the invention is directed to improved methods and devices that provide for skill-based, sports wagering.

More specifically, the present invention relates to wagering on a wide range of sporting competitions (e.g., horse racing, NASCAR racing, team events such as football and soccer) between various competitors (e.g., racehorses, NASCAR drivers, sports teams) and is directed to a means for utilizing the digital database of information that relates to such competitors and the prior sporting events in which they have competed to identify “value” wagers (i.e., those having the highest percentage probability of generating a positive return) for the sporting events in which such competitors are or will be competing.

### 2. Description of the Related Art

Sports wagering is a very important part of our economy and is predicted to become even more important as more states provide for legalized sports wagering in order to provide these states with increased amounts of collected taxes.

Sports wagering on a wide range of sporting events contributes significantly to the collected taxes of many states. Such wagering takes one of two forms: “parimutuel” or “fixed odds” wagering and it is important to understand how each works.

Parimutuel wagering is a wagering or betting system wherein all the amounts of money wagered by a group of players/system users on each of the possible outcomes of a contest (e.g., which horse from among a field of horses will win a specific horse race) are placed together in a pool; taxes and the “house take” are removed (e.g., 14.25%) so as to yield a payoff amount that is shared among those players or system users who correctly picked the winner of the contest (i.e., winning players). By the use of a specialized machine, or totalizator/tote, which keeps track of all the bets, instantaneously computes the sum of the wagers or bets made on any one of the possible outcomes in a contest, and display this information, one is able to know when placing one's bet the various odds, depending on which outcome one bets, for winning some multiple of one's original bet these odds often impact the wager that a player or system user will make and add to the excitement of such games.

Thus, for the example of a horse race, how much a player wins relative to one's bet depends on the payoff amount and the sum of the amounts that the other winning players also wagered. From knowing how much has been wagered on each horse in the race and thus the total amount wagered at the time of one placing his or her bet, one can get an idea of how much one might win if the percentages of money being wagered on the different horses stay the same until the start of the race when no further bets are accepted and the winning odds for the various horses are then determined.

Parimutuel betting differs from “fixed-odds” betting in that the final payout is not determined until the pool is closed-in “fixed odds” betting, the odds are often being offered by a bookmaker who is responsible for making the required payouts to the winning users from the monies that the bookmaker presumably collects from those users who placed non-winning bets on the same race with the bookmaker. If these monies are insufficient to make the required wining payouts, the bookmaker is expected to make up the balance of any needed funds from the bookmaker's own surplus funds.

Sports wagering has generally evolved as part of the larger entertainment industry by developing a wide assortment of innovations, including: (1) cash-accepting, wagering terminals or machines, (2) self-service wagering machines, (3) advanced deposit wagering—first using the telephone and eventually using the internet and online mobile devices, (4) interstate simulcast wagering in the late 1970's, (5) intrastate simulcast wagering in the early 1980's, (6) new types of wagering opportunities, including wagering on previously-run, order of finish contests as part of what has become known as “instant wagering” or “instant racing,” or, for the horse racing industry, “historic horse racing” (HHR), and (7) online, mobile wagering.

Online, mobile wagering involves a player signing up and establishing a player's secure account on one of the many websites that provide online, sports wagering (e.g., see Xpressbet.com) by completing the website's registration process and making an initial deposit to fund the player's account. A player is then provided with the pertinent data that is relevant to an upcoming sporting event (e.g., identity of the competitors, appropriate background information on them, the listed odds).

The information relevant to an upcoming sporting event or competition is provided so as to aid the player in deciding which competitor in the field the player thinks will win or finish in any specific position at the end of the competition (i.e., information for handicapping the sporting event). There also exists various types of software that will assist a player in handicapping the sporting event on which the player is considering placing a wager (e.g., see Betmix.com).

After a player handicaps a sporting event, he or she then places his or her wager or wagers on the outcome of the event. Depending on the video capability of a player's mobile device, the player can watch the sporting event live or on a video replay to see its outcome.

Many of the methods and apparatus or systems associated with sports wagering have been patent protected, see, e.g., U.S. Pat. Nos. 2,182,875, 2,179,698, 5,411,258, 5,830,068, 5,846,132, 6,383,074, 6,358,150, 6,450,887, 6,736,725, 8,636,571, 8,814,700, 9,047,737, 9,053,608, 9,437,078, 9,443,392, 9,747,748, 10,510,210 and 10,720,024.

Despite the mature nature of sports wagering, there still exists the need and opportunity to further improve it, especially its online, mobile form, so as to enable it to provide its players with greater levels of excitement and entertainment while also complying with the established rules for sports wagering.

For example, there is for any sporting event usually a huge learning curve for a novice player to master before he or she can actually increase his or her chances of being able to make money on the payer's wagers. One typically needs to know: (a) a huge amount of background information on the competitors and how to wisely use it to try to determine the likelihood of a specific outcome in an upcoming sporting event (referred to herein as handicapping an event), (b) how to compare that likelihood with the prices or odds being offered in the market, (c) what types of bets are available and which of these have the best odds of being winners considering the background information of the upcoming sporting event (referred to herein as having a wagering strategy), and (d) what amounts for one's various wagers or bets has the greatest likelihood of allowing a player to make money on his or her wagers (referred to herein as employing a money management strategy or using a herein defined “value index” to guide one in placing his or her wagers).

Even for very experienced players, there is still always the immense challenge of how to most wisely use the background or handicapping information available to a player and what wagering and money management strategies to employ to increase a player's enjoyment of sports wagering. Unfortunately, current sports wagering platforms offer only a limited amount of information on how to most wisely use the available handicapping information and almost no information on how to most wisely use various wagering or money management strategies. The present invention seeks to address and provide various remedies to the above-identified problems that currently present barriers to a player's maximum enjoyment of sports wagering.

### BRIEF DESCRIPTION OF THE DRAWINGS

FIG. 1 is a block diagram that illustrates the general architecture of a sports wagering platform that enables one or more players or users to make various types of wagers on any of a number of sporting events.

FIG. 2A is a flow diagram that illustrates the elements of a preferred embodiment of the present invention which takes the form of a system that enables one wishing to bet on sporting events (i.e., a player) to make skill-based bets.

FIG. 2B is a diagram that illustrates the general method used by the system shown in FIG. 2A.

FIG. 3A is an example, from the sport of horse racing, of a screen shot of a user interface of the present invention that is used to visually communicate some of its possible outputs to the mobile device of a player.

FIGS. 3B and 3C show screen shots, of live TV or simulcast broadcasts of horse races, where some of the possible output from the present invention is shown in an overlay box that is located on the right side of these screen shots, while their left-hand sides shows actual, live shots of action that is occurring at the track where the upcoming race is scheduled to be held.

FIGS. 3D and 3E show screen shots in a situation where a long shot prediction from the system's Interesting Pick's portion has actually won and this has led to indica being added to these screen shots that identifies this interesting pick.

FIG. 4A is a flow diagram that illustrates the general process used by its forecast module to generate a forecasted outcome for an upcoming sporting event. The screen shots shown in this diagram are applicable to horse racing.

FIG. 4B illustrates a screen shot or user interface that allows a player to use or select the present invention's identified top handicapping factors or “Top Factors”, or, alternatively, select their own handicapping factors by selecting a “Build Your Own” option.

FIG. 4C illustrates a screen shot or user interface that is presented to a player once he or she has selected the “Build Your Own” option. FIG. 4C shows a multitude of handicapping factors from which the player is directed to pick ten handicapping factors for use in generating the player's forecast for the outcome of the upcoming sporting event (which in this instance is a horse race).

FIG. 5 shows a live screen shot of commentators sharing such a discussion on the wagering for an upcoming race and imposed on this shot is an overlay that shows some of the present invention's predictions for this race. Also shown are how some of the elements of the present invention combine with a live TV broadcast or simulcast display to yield this screen shot.

### DESCRIPTION OF THE PREFERRED EMBODIMENT

Before explaining at least one embodiment of the present invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

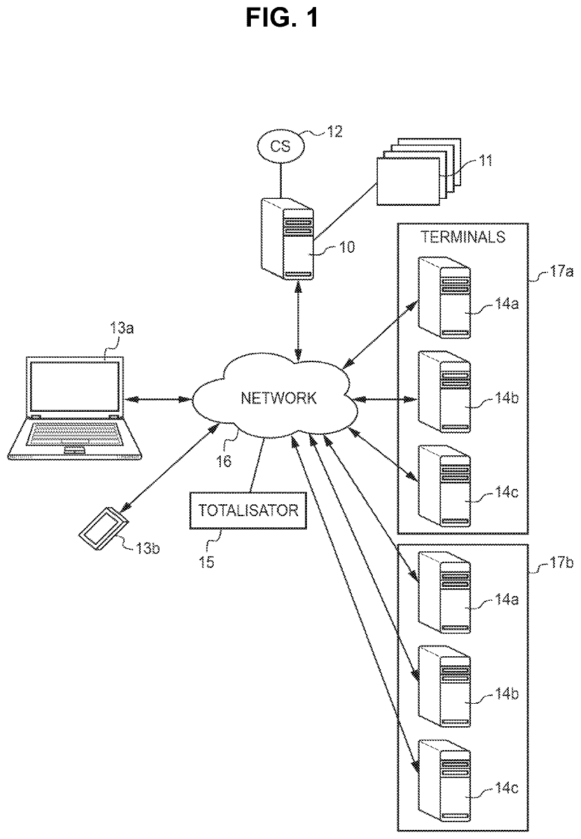

Shown in FIG. 1 is a block diagram that illustrates the general architecture of a sports wagering platform that enables one or more players or users to make various types of wagers on any of a number of sporting events. Such a platform includes the server 10 of an entity that provides wagering and its database 11 and control software 12 that allows this server 10 and the devices 13, terminals 14 and, a totalisator 15 (which is used for parimutuel wagering) with which the server communicates to accept the players' various wagered amounts, etc.

To do this, the server of the present invention connects over a network 16 (e.g., the Internet or other network) to its targeted players who are those with devices (e.g., laptop computer 13a, smart phone 13b, etc. with a touch-screen interface) and wish to place a wager via a web-browser-enabled 14c wagering terminal that is connected to a totalisator 15.

Also connected to this network are other players who are gathered to watch an upcoming sporting event and place wagers at a number of facilities (host 17a—where the actual event is occurring, and guest 17b—an off-site location) via the facilities' various types of wagering terminals (e.g., teller 14a, self-service 14b, web-browser enabled 14c).

A totalisator 15 or a similar machine is a key element of this wagering system as it performs a wide assortment of key tasks, including: (a) receiving and validating each individual wager placed on a sporting event, (b) totaling all the wagers into pools, and (c) for parimutuel wagers, continually computing and announcing to interested players the odds of each of the contestants winning the relevant sporting event based on the sum of the wagers placed at each instant in time before the beginning of the event, and calculating the payout of each wager based on the outcome of the competition.

The server's control software 12 is configured such that it facilitates all of the various functions and operations of the players' devices while also keeping track of all of the register players and their accounts, plus all the information pertaining to upcoming and relevant past sporting events and the background data on the competitors participating in these sporting events.

To better acquaint one with the software requirements and capabilities of the present invention, shown in this application's FIGS. are various user interface screen illustrations or screenshots that the control software of the present invention makes appear on the display of a player's device. These screenshots could be in a webpage or smart phone or tablet format, but are shown here in a smart phone format and in English. However, since the present invention is an international, multi-language, multi-currency invention, the native language environmental setting on each mobile device will be used to automatically select the language presented to the user. Date and currency formats will also match user preferences.

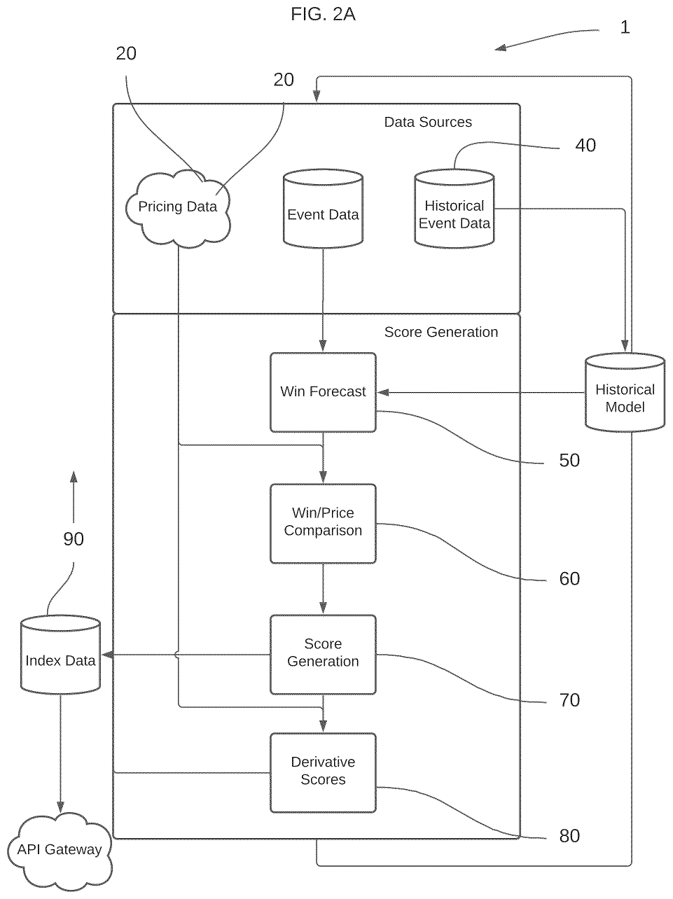

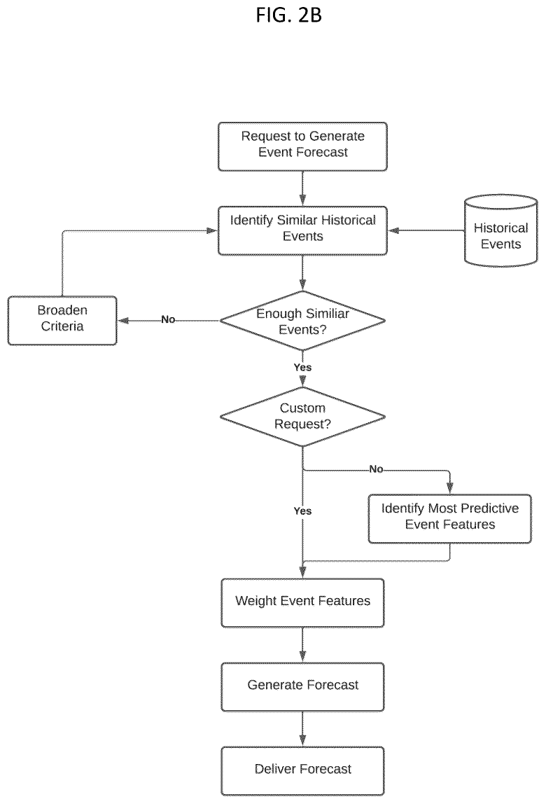

Shown in FIG. 2A is a flow diagram that illustrates the elements of a preferred embodiment of the present invention 1 which is in the form of a system or tool (note: it may also be defined as a method for skills-based wagering) that, for a player who wishes to bet on an upcoming sporting event, identifies the most relevant sporting event information or handicapping factors that can be used to predict the percentage probability that each of the competitors in the upcoming sporting event will do whatever is required (i.e., for a Win bet on a competitor, that competitor must win the event) to make the player's bet or wager a winning one. These percentage probability predictions for each of the competitors are then combined with the information pertaining to the relevant odds for the player's bet that the markets are currently offering on each of the competitors to identify the “value bets” (i.e., those with the greatest likelihood of allowing a player to make money on his or her bet) that are available on the upcoming event. These “value bets” are identified by assigning them a “value index” that is a score between 1 to 100, and wherein those bets with the highest score or “value index” have the greatest likelihood of allowing a player to make money on his or her bet.

FIG. 2B illustrates the general method used by the system shown in FIG. 2A.

The key elements in this system are seen to include:
(a) a pricing module 20 that obtains the market's currently offered relevant odds on each of the competitors that a player could place a specific type of bet in the upcoming sporting event on which the player has decided to place a bet,
(b) an “upcoming events” or events module 30 that is configured to both compile and/or obtain all of the relevant information for the sporting event on which a player has decided to place a bet, and then stores this information in a manner so that it can be used to identify prior similar sporting events which can be studied to reveal the primary attributes or characteristics of the winners of these prior, similar sporting events,
(c) a searchable, historical or “prior sporting events” database or module 40 that is configured to contain all of the information pertaining to prior sporting events (including the outcomes) on which the player could conceivably place a bet and to store it in the same manner as the events module so that sporting events similar to the one which on the player has decided to place a bet can be easily identified for analysis,
(d) a multiple portion, forecast module 50 that is configured to: in its prior, sporting events or historical portion, (i) search in an expedited manner, using artificial intelligence in the form of a trained convolutional neural network, the historical event database to locate sporting events similar to the one on which the player has decided to place a bet and then to (ii) analyze these located sporting events to determine the “shared characteristics of their past winners;” and (iii) compare these “shared characteristics of their past winners” to identify the competitor from the upcoming sporting event that shares the greatest number of these shared-winning characteristics.

In its predictions portion, it then uses the outcomes of prior, similar races to: (i) predict or forecast the percentage probability (i.e., a WIN %) that this competitor with the greatest number of shared-winning characteristics will actually do whatever is required to make the player's bet a winning one; it then (ii) proceeds in this manner to calculate a similar WIN % for all of the other competitors in the sporting event on which the player has decided to bet,
(e) a WIN/Price or WIN/Odds or Value comparison module 60 that is configured to use the WIN % for a competitor and combine it with that competitor's current odds or market price (for the necessary actions happening in order to make the bet a winner) in such a way as to identify the “value bets” (i.e., those with the greatest likelihood of allowing a player to make money on his or her bet or wager [whatever the nature of the wager]) that are available to be bet upon in the upcoming sporting event,
(f) a score generation module 70 that is configured to transform or rank order these identified “value bets” so that they are easily recognizable by placing them on a 1-100 scale, where the “value bets” are those with the very greatest likelihood of allowing a player to make money on a sporting event on which a player has decided to place a bet; these bets are assigned the greatest scores or value indexes (“Value”),
(g) a derivative module 80 that is configured to use the outputs of the forecast, WIN/Price and score modules to identified certain types of bets that, because of their current pricing and WIN % etc., might be of interest to the player (e.g., longshot bets that will offer great returns if they win),
(h) a player searchable index database 90 that is configured to store the outputs of the forecast, WIN/Price, score and derivative score modules and continually updates them as the pricing and the circumstances surrounding the event change, and
(i) a user interface 100 that is configured to allow a player to interact with the system or its internet-enabled tool and receive its advice on how to skillfully bet an upcoming sporting event.

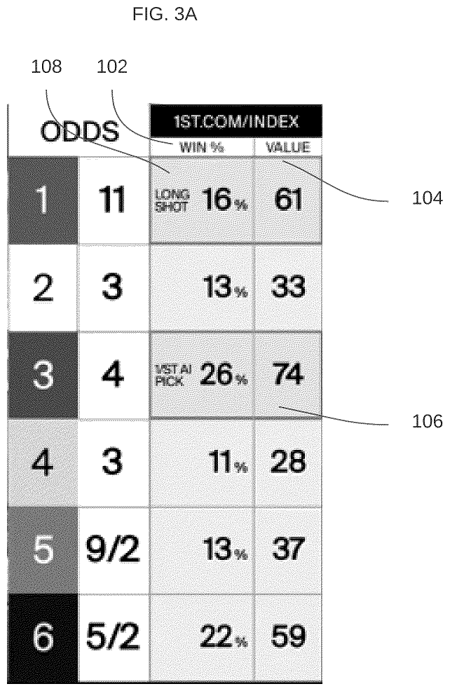

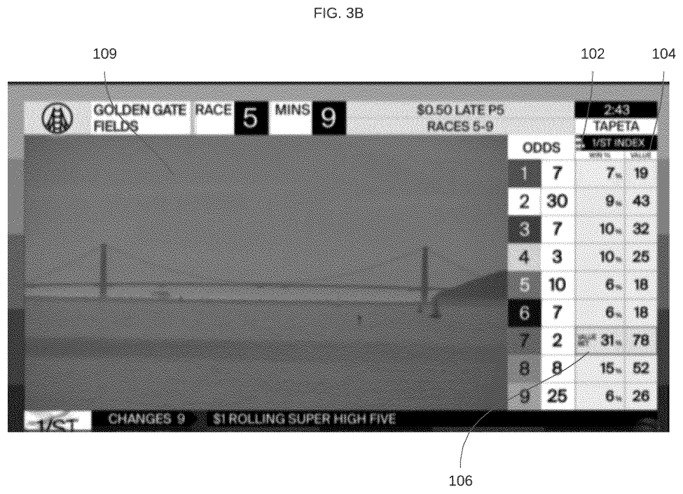

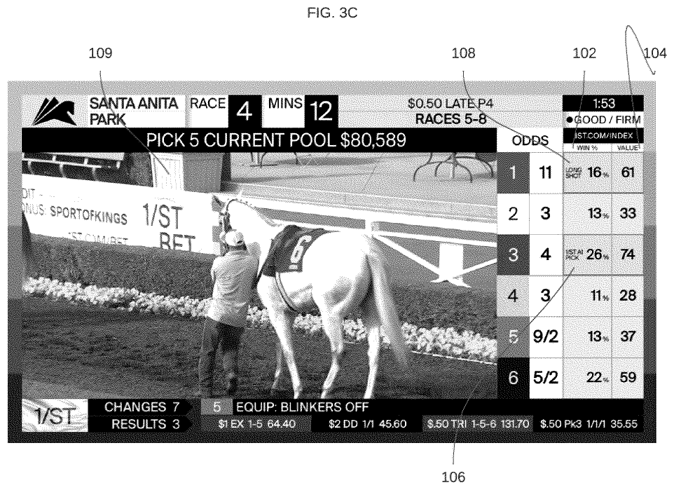

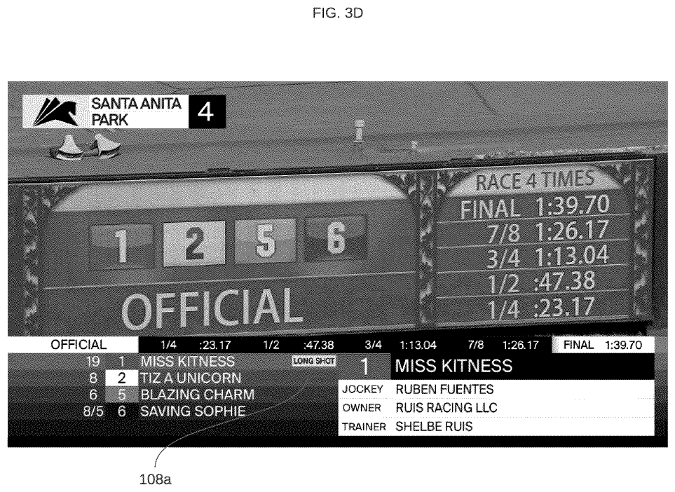

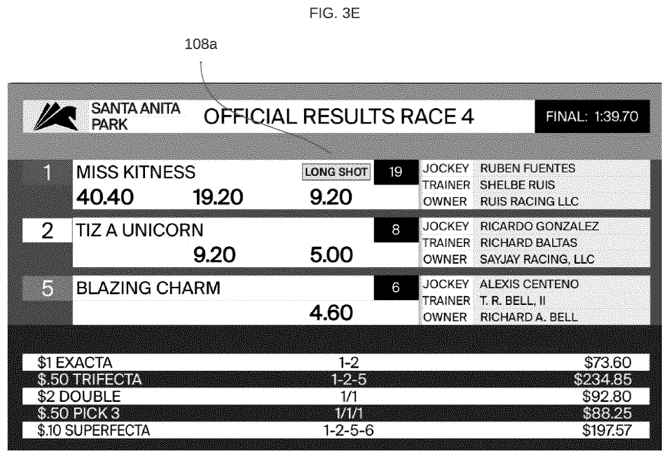

Shown in FIG. 3A is an example of a screen shot of a portion of a user interface of the present invention that is used to visually communicate some of the possible outputs of the system to a player who is using the present invention on, for example, a mobile device which has a display screen and internet access. In this example, the player wants to place a bet on one or more of eleven racehorse who are entered in an upcoming race.

These racehorses are identifiable by their numbers which are listed in the column on the far, left-hand side of this screen shot. This screen shot is also seen to have the current odds for each of these racehorses actually winning the upcoming race listed to the immediate right of each racehorse's number. Some of the outputs of the current invention are seen in the two columns that appear on the right side of this screen shot.

These outputs are seen in a first or WIN % portion 102 that lists the system's percentage probability that competitor, whose number is listed on the far left, will actually win the competition (i.e., a WIN %). A second or Value portion 104 lists the system's computed score or value index for a win bet on each of the competitors. A third or Win Pick's portion 106 identifies the competitor that has the highest percentage probability of actually winning the upcoming competition. Additionally, a fourth or Interesting Pick's portion 108 identifies any competitor that are especially significant because it is predicted to offer a player the chance to make an especially skilled wager (e.g., a good longshot bet or one that is a good “value bet”).

FIGS. 3B and 3C show screen shots of live TV or simulcast broadcasts of horse races where commentators or broadcasters are possibly discussing the wagering options for an upcoming race and where some of the output from the present invention is shown in an overlay box that is located on the right side of these screen shots. This box contains the identification of the competitors and each of their odds, and the first to fourth portions 102-108 of the user's interface described above. The left-hand side of these screen shots shows actual, live shots of action 109 that is occurring at the track where the upcoming event or race is scheduled to be held.

Other examples of how the outputs of the present invention may be used in the screen shots of live TV or simulcast broadcasts of horse races are shown in FIGS. 3D 28-3E. FIG. 3D shows the situation where a long shot prediction from the system's Interesting Pick's portion has actually won and this has led to indica 108a announcing this situation being added to the displayed results of the race and where this screen shot also includes a live shot of a board announcing the results to those at the race. FIG. 3E shows a similar broadcasted, screen shot that contains only the race's results.

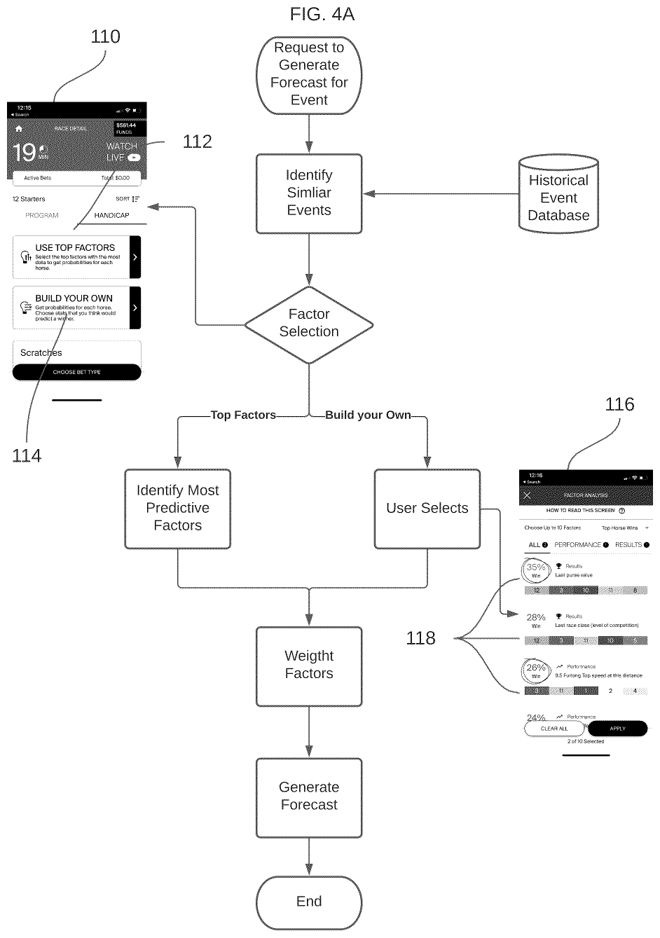

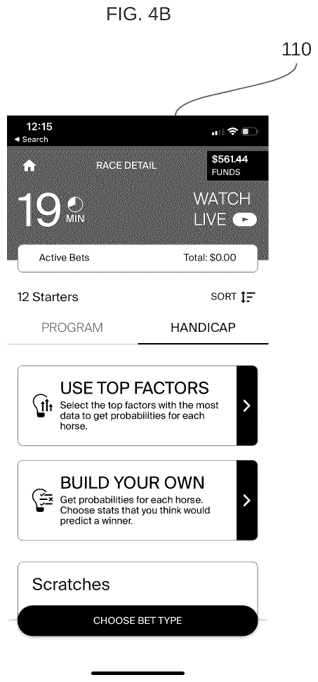

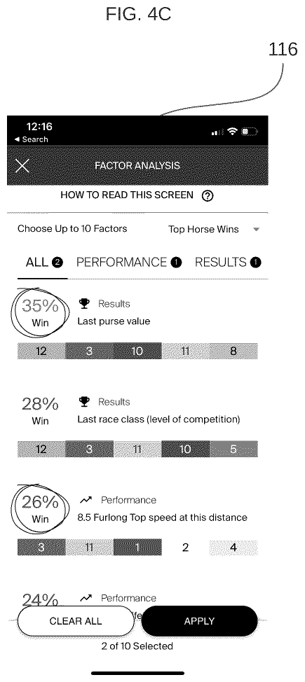

To predict the percentage probability that each of the competitors in an upcoming sporting event (on which a player or user (e.g., a generic consumer of the outputs of the present invention) of the present invention wishes to bet) will do whatever is required to make the player's bet on one of the competitors a winning one (and subsequently combining these predictions with market pricing or “odds” to identify the “value bets” that are available on an upcoming event) the system of the present invention uses its forecast module 50. The process used by this module is generally shown in FIG. 4A.

This module utilizes its artificial intelligence platform to search its historical event database to identify prior sporting events that are similar to the one on which the player wishes to bet. Attributes that may be used to select prior, similar sporting events include: (a) for horse racing: nature and condition of the track surface, class of the race, field size, the identity of the racetrack, performance metrics (e.g., speed exhibited during various portions of a race) for each of the competitors in these prior events, etc., (b) for a football game: identity of the competing teams, location of the field on which the game is being held, key players who started for each team, identity of the coaches, team's respective won-lost records coming into the game, etc.

The forecast module then studies these prior, similar sporting events to reveal the primary attributes or characteristics of the winners (winners' characteristics or the notable values of the handicapping factors applicable to the prior winners) of these prior events. Using the winners' characteristics, the system identifies the competitor, from the upcoming sporting event, that shares the greatest number of these winners' characteristics.

Knowing that some players, especially those considering themselves to be talented handicappers, may want to select their own handicapping factors, the present invention has a variation of the above process that allows for this. This is illustrated in FIG. 4A by the screen shot or user interface 110 on the left-hand side of FIG. 4A that allows a player to use or select the present invention's identified top handicapping factors or “Top Factors” which is shown in a first portion 112 of this screen shot. Alternatively, the player can select their own handicapping factors by selecting a “Build Your Own” option that is shown in a second portion 114 of this screen shot and as further shown in FIG. 4B. Upon selecting the “Build Your Own” option, the player is presented with a screen shot or user interface 116 like that shown on the right hand-side of FIG. 4A and as further shown in FIG. 4C.

In FIG. 4C, a player can scroll through a multitude of handicapping factors from which the player is directed to pick up to ten handicapping factors 118 for use in generating the player's forecast for the outcome of the competition. The handicapping factors shown in FIG. 4C are for a horse race. For example, from the system's analysis of prior similar horse races, it has been found that the horse with the fastest speed at a race's 8.5 furlong distance won such races 24% of the time.

Once a player has picked his or her ten handicapping factors, the forecast module applies a certain weighting factor to each one. Such weighting factors are determined by the analysis of the prior similar competitions and wherein the highest weighting factor is designated to that handicapping factor which was most successful in predicting the winners of the prior, similar competitions. The sum of these products of handicapping and weighting factors are then applied to the various competitors in the upcoming competition to arrive at a forecast for the winner of the upcoming sporting event.

In general. the present invention's forecast module predicts or forecasts the percentage probability that the competitor with the greatest number of winners' characteristics will actually do whatever is required to make the player's bet a winning one (i.e., a WIN %). The system then proceeds in this manner to calculate a similar WIN % for all of the other competitors in the upcoming sporting event.

The system next utilizes its WIN/Price module 60 to combine the WIN % for a competitor with that competitor's current odds or market price in such a way as to identify the “value bets” (i.e., those with the greatest likelihood of allowing a player to make money on his or her bet or wager) that are available on the upcoming sporting event.

Shown below is an example of an algorithm that the present invention can use to identify the “value bets”:

$${v}_{i} = ln ( 1 + ln ( 1 + ( ( Tote {Odds}_{i} + 1 ) * 1 ST Win {\%}_{i} * \% {Pool}_{i}^{3 / 4} ) ) ) \\ {V}_{i} = int ( \frac{{v}_{i} - \text{.03}}{\text{.33} - \text{.03}} * 100 ) \\ {Value}_{i} = \{ \begin{matrix}99 , & {V}_{i} > 99 \\ 1 , & {V}_{i} < 1 \\ {V}_{i} , & otherwise\end{matrix}$$

Where the definitions for the symbols used above are:
vᵢ=An intermediate value (prior to scaling in the next steps) for the ith participant in the event
Valueᵢ=The Value index for the ith participant in the event
int=The integer function which converts a real number into an integer

To make “value bets” more easily recognizable, the system's score module 70 transforms or rank orders these identified “value bets” by placing them on a 1-100 scale, where the “value bets” with the very greatest likelihood of allowing a player to make money on his or her bet are assigned the greatest scores or value indexes (“Value”).

Further towards the goal of making attractive bets more recognizable and obvious to a player, the present invention's derivative score module is configured to use the outputs of the system's forecast, WIN/Price and score modules to identified certain types of bets that because of their current pricing and WIN % etc. might be of special interest to a player. For example, the derivative score module defines what it calls a “best bet” (i.e., one in which the competitor bet upon has a good likelihood of winning (e.g., a Win %>20%) and yielding a payout that is at or better than a fair price (e.g., Value Index of >60)) and utilizes its user interface to bring such “best bets” to the attention of a player.

Similarly, this module defines what it calls a “longshot bet” (i.e., one in which the competitor bet upon has long odds (e.g., >10/1) to win and is more likely to win than their odds suggest (e.g., Value Index of >60)), and also brings such “longshot bets” to the attention of a player. The process for the generation of these derivative bets is generally shown in FIG. 4. The present invention's index database is configured to store the outputs of the system's forecast, WIN/Price, score generation and derivative modules and continually update them as the pricing and the circumstances surrounding the event change.

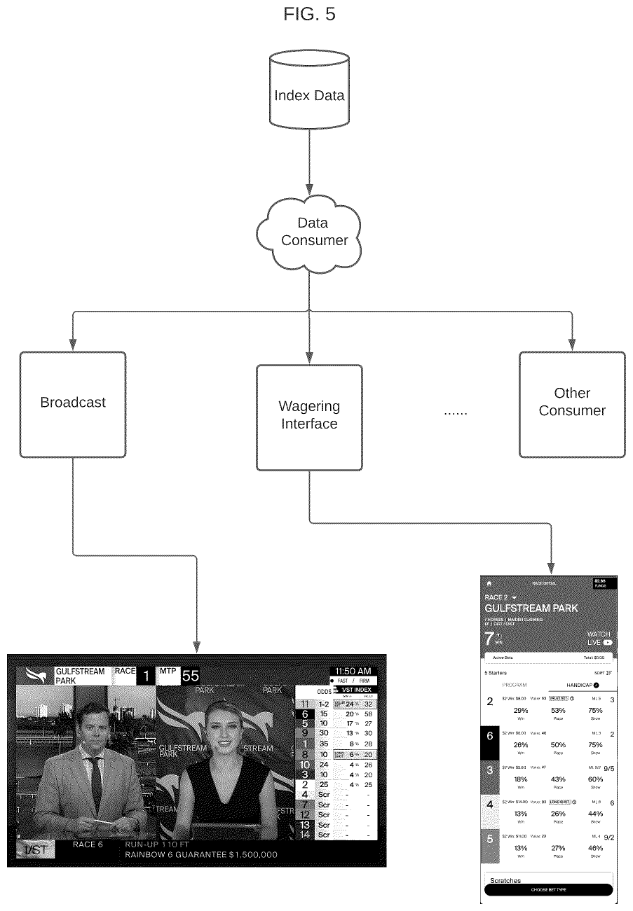

There are many ways in which the present invention can be used in the sports wagering industry. For example, the results of the present invention for horse race wagering can be displayed in a box overlay of a TV or simulcast display and in which the commentators or broadcasters are using this box to discuss the wagering options for an upcoming race. This integration also gives the broadcasters the opportunity to talk about why they disagree or agree with the betting picks for an upcoming race and provides the possibility of turning those who are watching the broadcast into players. FIG. 5 shows a live shot of commentator sharing such a wagering discussion and imposed on this shot is an overlay that shows some of the present invention's predictions for the race the commentators are discussing. Also shown are how some of the elements of the present invention combine with a live TV broadcast or simulcast display to yield the screen shot discussed above.

The foregoing is considered as illustrative only of the principles of the present invention. Further, since numerous modifications and changes will readily occur to those skilled in the art, it is not desired to limit the invention to the exact construction and operation shown and described herein. Accordingly, all suitable modifications and equivalents may be resorted to, falling within the scope of the invention.

We claim:

1. A wagering tool that allows a player to make skill-based bets on an upcoming sporting event that is contested between various competitors, and for which there have been similar prior sporting events, said tool comprising:
a pricing module configured to provide the odds for each of said various competitors in a specified, upcoming sporting event,
a searchable, historical events database configured to store relevant information pertaining to said prior sporting events, including the conditions and outcomes for each of said prior sporting events and the performance metrics for each of said competitors in each of said prior sporting events,
a forecast module having:
(i) a historical portion configured to:
(a) search said historical events database to identify from said prior sporting events those which have relevant information that is similar to that for said upcoming sporting event,
(b) analyze said identified, prior, similar sporting events to determine a shared performance metric that is shared by their winners, and
(c) analyze the performance metrics for each of said competitors in said upcoming sporting event upon to identify the degree to which each of said competitors shares said winner's shared performance metric,
(ii) a predictions portion configured to predict the percentage probability that each of said competitors from said upcoming sporting event will actually do whatever is required to make said bet of said player a winning bet,
a value module configured to compute a value index for each of said competitors from said upcoming sporting event,
a searchable index database configured to store said analysis, predictions, and computations of said forecast and value modules, and
a user interface configured to allow said player to interact with said wagering tool.

2. The wagering tool as recited in claim 1, further comprising:
a score generation module configured to rank order said computed ratios of said percentage probability over said odds for each of said competitors from said upcoming sporting event.

3. The wagering tool as recited in claim 1, further comprising:
a derivative module configured to analyze the outputs of said modules to identify, for said upcoming sporting event, an available bet on a competitor that, because of the returns said available bet offers, could be of interest to said player.

4. The wagering tool as recited in claim 2, further comprising:
a derivative module configured to analyze the outputs of said modules to identify, for said upcoming sporting event upon which said player is considering placing a bet, an available bet on a competitor that, because of the returns said available bet offers, could be of interest to said player.

5. The wagering tool as recited in claim 1, further comprising:
an events module configured to compile and store relevant information for each of a plurality of upcoming sporting events, including the conditions for each of said upcoming sporting events and the performance metrics for each of said competitors in each of said upcoming sporting events

6. The wagering tool as recited in claim 4, further comprising:
an events module configured to compile and store relevant information for each of a plurality of upcoming sporting events, including the conditions for each of said upcoming sporting events and the performance metrics for each of said competitors in each of said upcoming sporting events.

7. The wagering tool as recited in claim 1, wherein:
said value index is computed using the ratio of said percentage probability over said odds for each of said competitors, and
said available bets are chosen from the group including “value bets,” “best bets” and “longshot bets.”

8. The wagering tool as recited in claim 4, wherein:
said value index is computed using the ratio of said percentage probability over said odds for each of said competitors, and
said available bets are chosen from the group including “value bets,” “best bets” and “longshot bets.”

9. The wagering tool as recited in claim 1, wherein:
said index database further configured to continually update said analysis and predictions as the pricing and the circumstances surrounding said upcoming sporting event change.

10. The wagering tool as recited in claim 4, wherein:
said index database further configured to continually update said analysis and predictions as the pricing and the circumstances surrounding said upcoming sporting event change.

11. The wagering tool as recited in claim 1, wherein:
said searching of said historical events database uses a trained, convolutional neural network.

12. The wagering tool as recited in claim 4, wherein:
said searching of said historical events database uses a trained, convolutional neural network.

13. The wagering tool as recited in claim 1, wherein:
said user interface having a Wins % portion that displays said predicted percentage probability that each of said competitors from said upcoming sporting event will do whatever is required to make said bet of said player a winning bet.

14. The wagering tool as recited in claim 4, wherein:
said user interface having a Wins % portion that displays said predicted percentage probability that each of said competitors from said upcoming sporting event will do whatever is required to make said bet of said player a winning bet.

15. The wagering tool as recited in claim 1, wherein:
said user interface having a Value portion that displays said computed value index for each of said competitors from said upcoming sporting event.

16. The wagering tool as recited in claim 4, wherein:
said user interface having a Value portion that displays said computed value index for each of said competitors from said upcoming sporting event.

17. The wagering tool as recited in claim 1, wherein:
said user interface having a Win Picks portion for an upcoming sporting event that identifies said competitor that has the highest predicted percentage probability that said competitor will do whatever is required to make a bet of said player a winning bet.

18. The wagering tool as recited in claim 4, wherein:
said user interface having a Win Picks portion for an upcoming sporting event that identifies said competitor that has the highest predicted percentage probability that said competitor will do whatever is required to make a bet of said player a winning bet.

19. The wagering tool as recited in claim 17, wherein:
said user interface further having an Interesting Picks portion that specifies a competitor identified by said derivative module who, because of the returns said identified competitor offers, could be of interest to said player.

20. The wagering tool as recited in claim 18, wherein:
said user interface further having an Interesting Picks portion that specifies a competitor identified by said derivative module who, because of the returns said identified competitor offers, could be of interest to said player.
